(19) United States
(12) Patent Application Publication
(10) Pub. No.: US 2019/0140429 A1
(43) Pub. Date: May 9, 2019

(54) SMART CIRCUIT BREAKER

(71) Applicant: ABB Schweiz AG, Baden (CH)

(72) Inventors: Leonardo Dorea Mascarenhas, Agawam, MA (US); Tapas Ranjan Rout, Rasoolpura (IN); Rafael Enrique Higuera, Durham, NC (US); Cameron Graham Molloy, New Britain, CT (US); Jeremy Robert Baillargeon, Southington, CT (US)

(21) Appl. No.: 15/806,738

(22) Filed: Nov. 8, 2017

(51) Int. Cl. H02B 1/24; H01H 71/04; H01H 71/02; H02B 1/052

(52) U.S. Cl. CPC H02B 1/24; H02B 1/052; H01H 71/02; H01H 71/04

(57) ABSTRACT

A circuit breaker is provided. The circuit breaker includes a housing, a circuit protection device disposed within the housing and operable to i) sense operating conditions associated with at least one current path through the circuit breaker and ii) selectively open the at least one current path based on the sensed operating conditions, a processing device communicatively coupled to the circuit protection device, the processing device operable to collect operating conditions data from the circuit protection device, the operating conditions data including the sensed operating conditions and a trip indication that indicates whether the circuit protection device has opened the at least one current path, and at least one communications interface communicatively coupled to the processing device, the at least one communications interface operable to receive the operating conditions data from the processing device to facilitate exporting the operating conditions data to a remote computing device.

### BACKGROUND

The field of the disclosure relates generally to circuit breakers, such as a ground fault circuit interrupt (GFCI) circuit breaker, an arc fault circuit interrupt (AFCI) circuit breaker, or a dual function circuit interrupt (DFCI) circuit breaker, and more particularly, to a circuit breaker with communications and processing capabilities.

Circuit breakers are well known devices for protecting circuits against electrical faults. At least some known circuit breakers may be so-called “smart” circuit breakers having a microcontroller monitoring operating conditions. The microcontroller may determine a fault condition and in response, causes a switch to open an associated circuit. At least some known “smart” circuit breakers may additionally provide a notification of the type of fault that occurred. However, while at least some “smart” circuit breakers communicate a fault to other devices, such circuit breakers may be relatively limited in diagnosing the cause of the fault.

### BRIEF DESCRIPTION

In one aspect, a circuit breaker is provided. The circuit breaker includes a housing, a circuit protection device disposed within the housing, the circuit protection device operable to i) sense operating conditions associated with at least one current path through the circuit breaker and ii) selectively open the at least one current path based on the sensed operating conditions, a processing device communicatively coupled to the circuit protection device, the processing device operable to collect operating conditions data from the circuit protection device, the operating conditions data including the sensed operating conditions and a trip indication that indicates whether the circuit protection device has opened the at least one current path, and at least one communications interface communicatively coupled to the processing device, the at least one communications interface operable to receive the operating conditions data from the processing device to facilitate exporting the operating conditions data to a remote computing device.

In another aspect, an electrical distribution center is provided. The electrical distribution center includes a mounting rail including a bus bar, at least one circuit breaker mounted to the mounting rail and electrically coupled to the bus bar, the at least one circuit breaker including a housing, a circuit protection device disposed within the housing, the circuit protection device operable to i) sense operating conditions associated with at least one current path through the circuit breaker and ii) selectively open the at least one current path based on the sensed operating conditions, a processing device communicatively coupled to the circuit protection device, the processing device operable to collect operating conditions data from the circuit protection device, the operating conditions data including the sensed operating conditions and a trip indication that indicates whether the circuit protection device has opened the at least one current path, and at least one communications interface communicatively coupled to the processing device, the at least one communications interface operable to receive the operating conditions data from the processing device to facilitate exporting the operating conditions data to a remote computing device.

In yet another aspect, a method of monitoring operation of a circuit breaker is provided. The method includes sensing operating conditions associated with at least one current path through the circuit breaker, the operating conditions sensed by a circuit protection device disposed within a housing of the circuit breaker, selectively opening, by the circuit protection device, the at least one current path based on the sensed operating conditions, determining that the at least one current path was selectively opened, and generating a corresponding trip indication, collecting, at a processing device disposed within the housing of the circuit breaker, operating conditions data from the circuit protection device, the operating conditions data including the sensed operating conditions and the trip indication, and exporting, using a communications interface communicatively coupled to the processing device, the operating conditions data to a remote computing device.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an exemplary circuit breaker with communications and processing capabilities.

FIG. 2 illustrates another exemplary circuit breaker with communications and processing capabilities.

FIG. 3 illustrates a close up view of the circuit breaker of FIG. 2.

FIG. 4 illustrates a schematic of an exemplary method for monitoring an electrical circuit using a circuit breaker with communications and processing capabilities.

FIG. 5 illustrates another exemplary circuit breaker with communications and processing capabilities.

FIG. 6 illustrates another exemplary circuit breaker with communications and processing capabilities.

FIG. 7 illustrates another exemplary circuit breaker with communications and processing capabilities.

FIG. 8 illustrates another exemplary circuit breaker with communications and processing capabilities.

FIG. 9 illustrates an electrical distribution center having a circuit breaker with communications and processing capabilities.

FIG. 10 illustrates an enlarged view of a portion of the electrical distribution center of FIG. 9.

FIG. 11 illustrates another electrical distribution center having a circuit breaker with communications and processing capabilities.

FIG. 12 illustrates an enlarged view of a portion of the electrical distribution center of FIG. 11.

FIG. 13 is a flow chart illustrating an exemplary method for acquiring operating conditions data from a circuit breaker.

FIG. 14 is a flow chart illustrating an exemplary method for collecting and distributing operating conditions data for a circuit breaker.

FIG. 15 is a block diagram of a circuit board that may be installed on a circuit breaker to provide the circuit breakers with communications and processing capabilities.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the present disclosure relate to a circuit breaker having communications and processing capabilities. The circuit breaker includes a communications interface for communicating with a remote computer system. The circuit breaker further includes a non-volatile memory that stores operating data and fault event data. This non-volatile memory may be removable for exporting the stored data, and/or the circuit breaker may transmit the stored data over a wired and/or wireless communications channel to a remote computing device (e.g., a computing device running management software). The operating data may include, for example, current readings, voltage readings, power readings, energy usage readings, waveform captures, temperature, transient events, and/or conditions that caused the circuit breaker to trip. This data can then be used for troubleshooting, software updates, individualized custom solutions, cloud based diagnostics software/database/management system, and/or branch circuit level metering.

Currently, at least some known circuit breakers may collect and analyze similar data, but that data is typically analyzed using a microcontroller contained within the circuit breaker to generate results data. The results data may be communicated to an external device, but the raw data collected by at least some known circuit breakers is not provided to the external device. Exemplary embodiments of the disclosure describe a circuit breaker that stores a complete data set to removable memory for later analysis, or that stores the complete data locally for later exporting to a remote computing device (e.g., a computing device running management software).

The embodiments described herein allow an end user to view transient event data to determine a cause of a circuit breaker tripping. Previously, at least some known circuit breakers did not store this data for subsequent analysis. Therefore it was generally known that the circuit breaker tripped, but no further analysis was possible. In contrast, embodiments of the circuit breakers described herein store operating data and fault event data to a removable and/or non-removable memory device, and export the stored data to a remote management computing device. The stored data may include current, voltage, and/or energy consumption measurements. Transient events may also be monitored. In the exemplary embodiments, the memory is non-volatile such that a tripping event does not cause data loss. The data may be transmitted to the remote management computing device via TCP/IP, Modbus, Bluetooth, NFC, cellular data, or any other secure data transmission protocol. The circuit breakers described herein store the operating data continually, and are capable of exporting this data to a management computing device that will process the data.

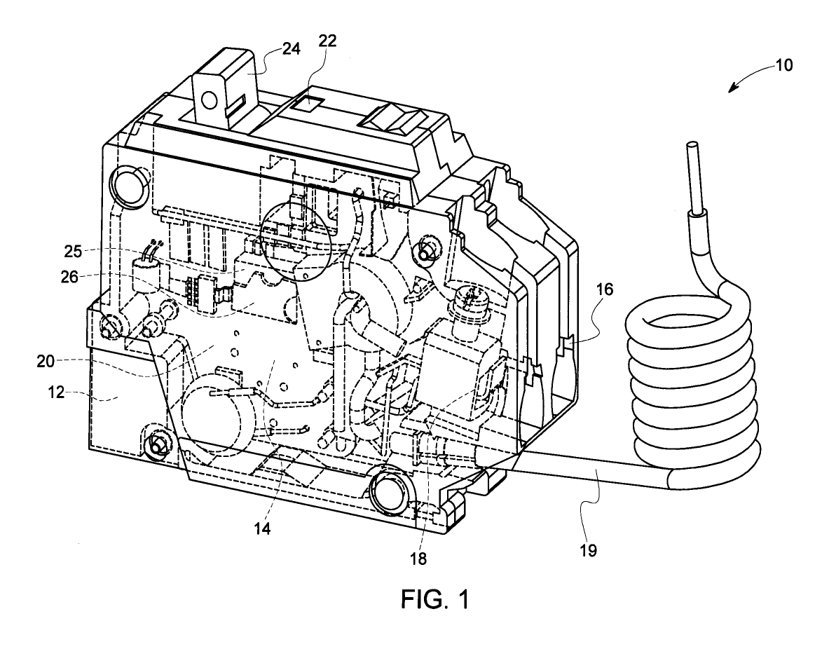

FIG. 1 illustrates a partially transparent perspective view of an exemplary Miniature Circuit Breaker (MCB) 10 having communications and processing capabilities. MCB 10 includes a housing 12 surrounding a circuit protection device 14 such as a GFCI, AFCI, or DFCI. Circuit protection device 14 further includes switching components and sensing components. Sensing components monitor operating conditions associated with at least one current path through MCB 10, and switching components are operable to open the at least one current path based on the monitored operating conditions. As will be appreciated by those of skill in the art, sensing components and switching components of circuit protection device 14 may be implemented using any suitable sensors, microprocessors, microcontrollers, and/or controllers.

A first load lug 16 and a second load lug 18 of MCB 10 are each operable to electrically couple MCB 10 to other devices. For example, first load lug 16 and second load lug 18 may each include a set screw to facilitate clamping a wire to the respective lug. In the exemplary embodiment, a first electrical path is defined within housing 12 between an electrical power source (not shown) and first load lug 16. Further, first load lug 16 is electrically coupled to the switching components to enable selectively opening the first electrical path between first load lug 16 and the electrical power source. Accordingly, first load lug 16 may also be referred to as a live load lug. Similarly, a second electrical path is defined within housing 12 between second load lug 18 and a neutral wire 109. Accordingly, second load lug 18 may also be referred to as a neutral load lug. Neutral wire 109 is electrically coupled to a neutral source.

One or more sensing components of circuit protection device 14 are operable to sense an operating condition associated with at least one current path through MCB 10, such as the first and second electrical paths. For example, circuit protection device 14 may be sense current flowing through first and second electrical paths, a temperature of circuit protection device 14, a current imbalance between the first and second electrical paths, a voltage difference between the first and second electrical paths, etc. In the exemplary embodiment, circuit protection device 14 is in communication with a circuit board 20. Circuit board 20 includes a processing unit (not shown in FIG. 1) operable to selectively activate the switching components of circuit protection device 14 in response to, for example, sensing one or more operating conditions exceeding associated thresholds. The processing unit may also be referred to herein as a processor or processing device. MCB 10 further includes an indicator 22 (e.g., an LED indicator) that indicates whether the switching components have been activated to open at least one current path in MCB 10 (i.e., the first electrical path between first load lug 16 and the electrical power source). Further, MCB 10 includes a manual switch 24, located in an accessible location, for manually opening at least one current path in MCB 10.

The processing unit of circuit board 20 is further operable to receive or collect operating conditions data from circuit protection device 14, and store the operating conditions data to non-volatile memory, such as a memory card 26. Specifically, circuit board 20 includes a communications interface 25 operable to communicatively couple memory card 26 to circuit board 20, and to transfer operating conditions data from circuit board 20 to memory card 26. Using non-volatile memory allows the stored data to be retrieved after a loss of power, such as when the MCB 10 is tripped. Further, in the exemplary embodiment, memory card 26 is removable from housing 12, allowing the stored data to be accessed by other devices. Operating conditions data includes data representing operating conditions of MCB 10 as sensed by the sensing components of MCB 10. Further, in the exemplary embodiment, the operating conditions data also includes a trip indication that indicates whether circuit protection device 14 has opened at least one current path in MCB 10. Specifically, in the exemplary embodiment, if a current path has been selectively opened (i.e., MCB 10 has tripped), circuit protection device 14 determines that the current path has been selectively opened, and generates a trip indication that indicates that the at least one current path has been selectively opened. If, however, the at least one current path has not been selectively opened (i.e., MCB 10 has not tripped), circuit protection device 14 generates a trip indication that indicates the at least one current path has not been selectively opened. This trip indication is included in the operating conditions data collected by the processing unit from circuit protection device 14.

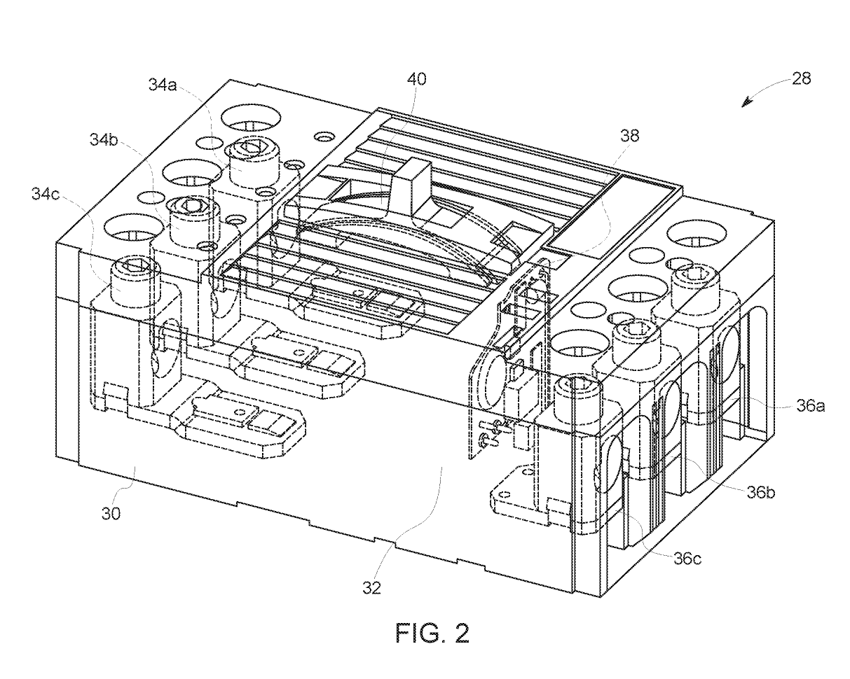

FIG. 2 illustrates a partially transparent perspective view of an exemplary embodiment of a mechanical molded case circuit breaker (MCCB) 28. MCCB 28 includes a housing 30 surrounding a circuit protection device 32 such as a GFCI, AFCI, or DFCI. Circuit protection device 32 operates similar to circuit protection device 14 (shown in FIG. 1). Further, MCCB 28 is similar in operation to MCB 10, but is designed to operate at higher power levels than MCB 10. In the exemplary embodiment, MCCB 28 is a three pole circuit interrupt circuit breaker for transmission and switching of three phase electricity. Each phase conducts current and requires a separate conductor coupled to a pole of MCCB 28. Further, each pole includes an associated a source lug 34a, 34b, 34c, and an associated load lug 36a, 36b, 36c with electrical paths defined between respective pairs of source lugs 34a, 34b, 34c and load lugs 36a, 36b, 36c. Circuit protection device 32 includes switching components and sensing components similar to those described above in relation to MCB 10 (shown in FIG. 1). Further, load lugs 36a, 36b, 36c and source lugs 34a, 34b, 34c are electrically coupled to the switching components. The switching components of circuit protection device 32 selectively open and close the current paths between load lugs 36a, 36b, 36c and source lugs 34a, 34b, 34c.

The sensing components of circuit protection device 32 are operable to sense an operating condition, such as current flowing through each pole, a temperature of circuit protection device 32, a current imbalance between the poles, a voltage difference between the poles, etc. In the exemplary embodiment, circuit protection device 32 is in communication with a circuit board 38. Circuit board 38 includes a processing unit (not shown in FIG. 2) operable to selectively activate the switching components of circuit protection device 32 in response to, for example, sensing one or more operating conditions exceeding associated thresholds. Further, a manual switch 40 is located in an accessible location on an exterior of housing 30 for manually opening the current paths between source lugs 34a, 34b, 34c and load lugs 36a, 36b, 36c.

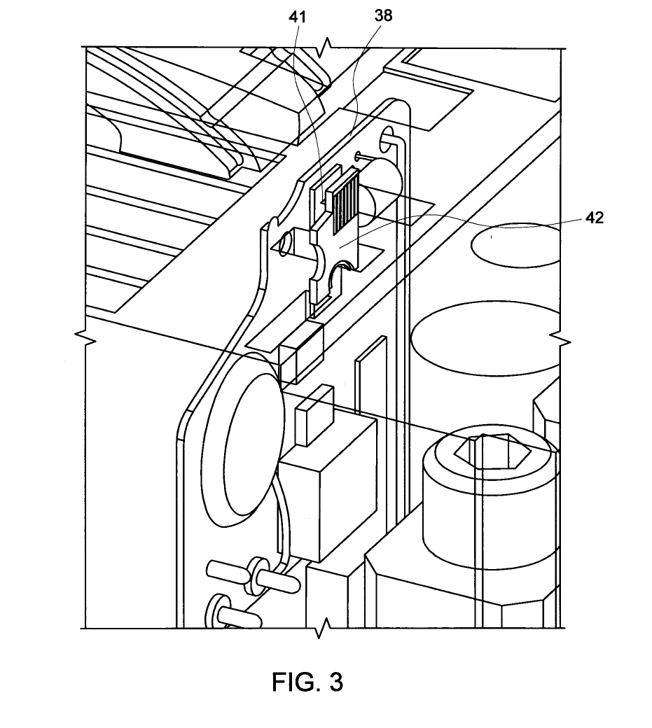

FIG. 3 illustrates an enlarged view of circuit board 38 of FIG. 2. The processing unit of circuit board 38 is operable to store operating conditions data representing the operating conditions sensed by the sensing components to non-volatile memory, such as a memory card 42. In the exemplary embodiment, the operating conditions data also includes a trip indication that indicates whether circuit protection device 32 has opened at least one current path through MCCB 28. Similar to circuit board 20 (shown in FIG. 1), circuit board 38 includes a communications interface 41 that communicatively couples circuit board 38 to memory card 42. Accordingly, communications interface 41 may also be referred to as a memory card interface. Accordingly, the processing unit of circuit board 38 can store the operating conditions data to memory card 42. In the exemplary embodiment, memory card 42 is removable, allowing the stored operating conditions data to be physically removed from MCCB 28.

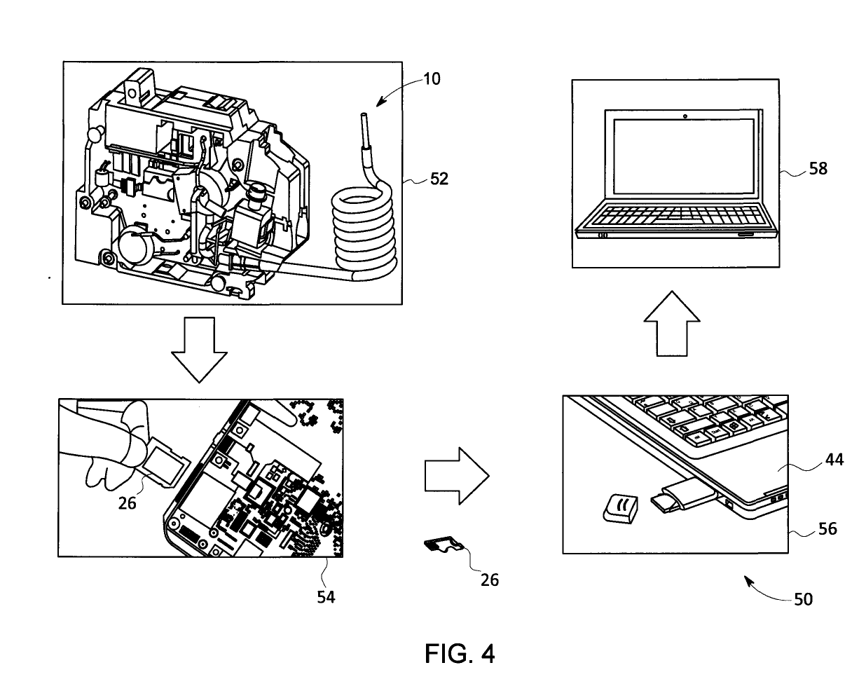

FIG. 4 illustrates an exemplary method 50 for monitoring an electrical circuit using MCB 10 (shown in FIG. 1). In block 52, operating conditions data representing the operating conditions of MCB 10 is stored to memory card 26. In block 54, memory card 26 is removed from MCB 10. In the exemplary embodiment, MCB 10 continues to function after memory card 26 is removed. Memory card 26 is then transferred to an analysis device 44 for further processing. Because memory card 26 is nonvolatile, saved operating conditions data remains stored independent of the MCB 10.

In block 56, memory card 26 is inserted into analysis device 44 and read by analysis device 44. Analysis device 44 may be, for example, a personal computer running an application for analysis of data contained on memory card 26. The operating conditions data may be stored in any format suitable for organization of values and time. For example, in some embodiments, the operating conditions data may be stored in a simple comma separated value text document, with each field having a time stamp and any corresponding measured information.

In block 58, analysis device 44 displays the operating conditions data to a user for analysis. The user may then troubleshoot operation of MCB 10 based on the displayed operating conditions data. Notably, in contrast to at least some known circuit breaker systems, in the exemplary embodiment, the operating conditions data includes not the trip indication, but also sensed operating conditions that may have led to any tripping of MCB 10. This allows a user to determine not only that MCB 10 tripped, but also what caused MCB 10 to trip.

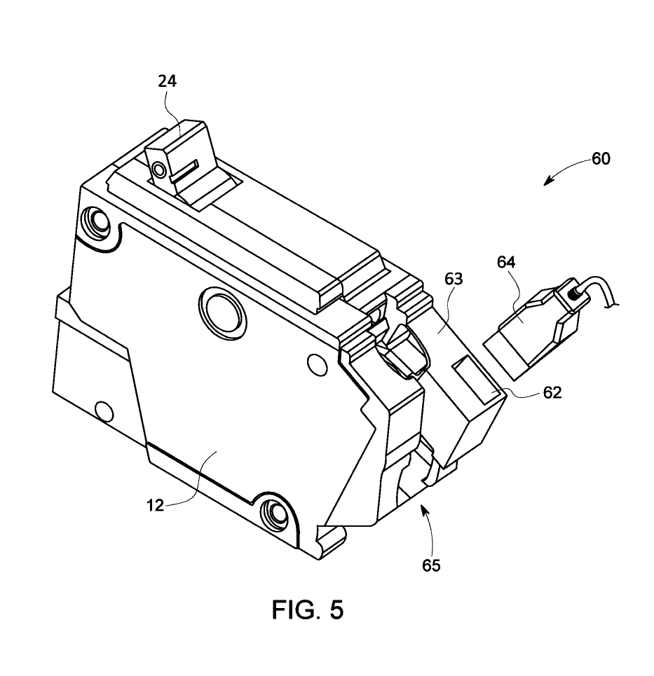

FIG. 5 illustrates an exemplary MCB 60. MCB 60 is similar in function to MCB 10 and the duplicative features will not be further described. MCB 60 does not contain a removable memory card, but instead a circuit board (now shown) similar to circuit board 20 (shown in FIG. 1) is operable to store operating conditions data representing operating conditions sensed by sensing components to a non-volatile memory device (not shown in FIG. 5) included on the circuit board. Further, in the exemplary embodiment, MCB 60 includes a communications interface in the form of a communications port 62 in communication with circuit board 20. Communications port 62 may be, for example, a universal serial bus (USB) port. Alternatively, communications port 62 may be any communications interface that enables MCB 60 to function as described herein.

In the exemplary embodiment, the processing device on circuit board is operable to transmit operating conditions data stored on the memory device to analysis device 44 through communications port 62. Specifically, a communications cable 64 (e.g., a USB cable) may be coupled between communications port 62 and analysis device 44. Accordingly, the operating conditions data may be transferred from MCB 60 to analysis device 44 through communications cable 64, for further analysis at analysis device 44.

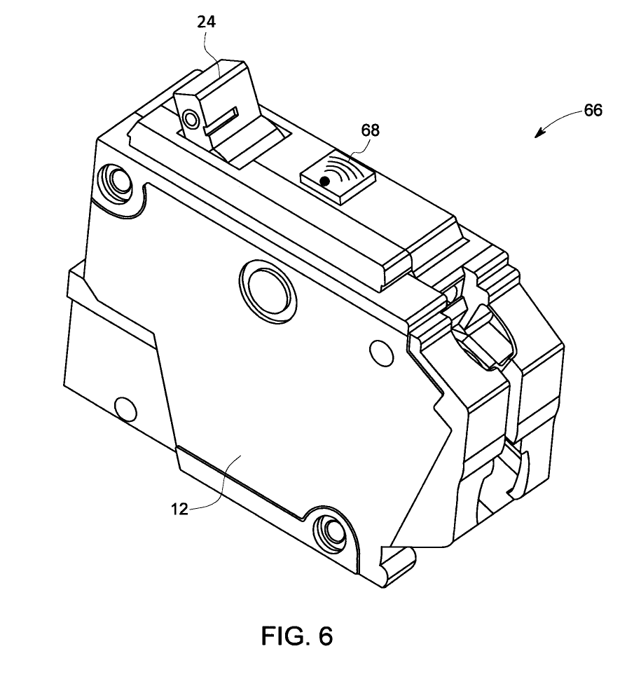

FIG. 6 illustrates an exemplary MCB 66 that is capable of wirelessly communicating operating conditions data. MCB 66 is similar in function to MCB 10 and MCB 60, and the duplicative features will not be described in detail herein. Similar to MCB 60, MCB 66 a processing unit of a circuit board installed within MCB 66 is operable to store operating conditions data to a non-volatile memory on the circuit board. Further, the circuit board is communicatively coupled to a wireless communications interface (not shown in FIG. 6) that facilitates wirelessly transmitting operating conditions data from MCB 66 to a remote computing device, such as analysis device 44 (shown in FIG. 4). In the exemplary embodiment MCB 66 includes a symbol 68 that indicates the wireless communication capabilities of MCB 66. The wireless communications device may communicate using cellular networks, Wi-Fi networks, Bluetooth, Near Field Communication (NFC), etc. The wireless communications interface is in communication with the processing unit of the circuit board. Specifically, the processing unit is operable to transmit data stored in the non-volatile memory to analysis device 44 using the wireless communications interface. The wireless communications interface may communicate with analysis device 44 through a network, an ad hoc network, or directly. According, stored operating conditions data may be transferred to analysis device 44 for analysis, as described herein.

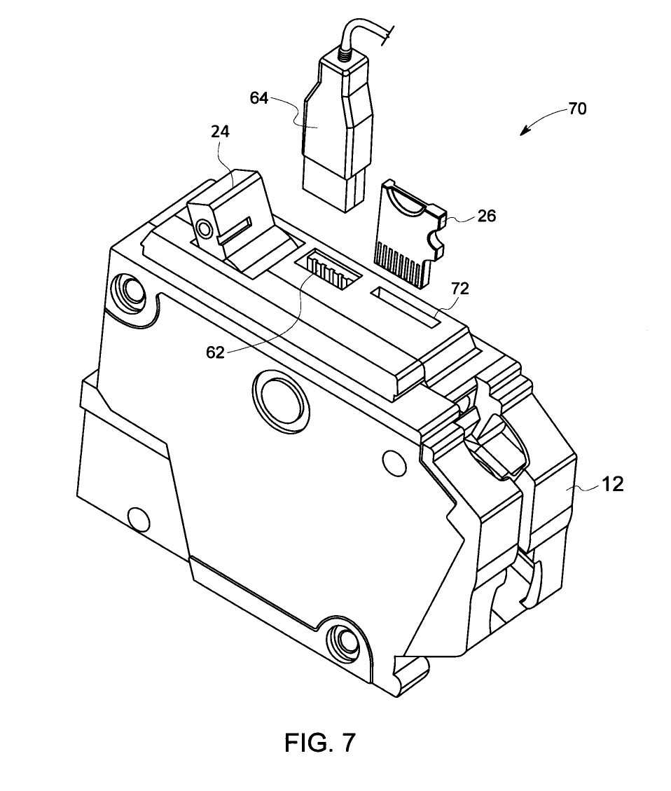

FIG. 7 illustrates an exemplary MCB 70 including two communications interfaces: a communications port 62 and a memory card interface 72 for receiving removable memory card 26. MCB 70 is similar in function to MCB 10, and the duplicative features will not be described in detail. In the exemplary embodiment, the processing unit of MCB 70 is operable to store operating conditions data to a non-volatile memory on the circuit board. Further, the operating conditions data may also be stored on memory card 26. Alternatively, the processing unit may store operating conditions only on removable memory card 26, without storing the data to the non-volatile memory on the circuit board.

Memory card interface 72 is accessible through a corresponding aperture defined in housing 12 of MCB 70, and is communicatively coupled to the processing unit of the circuit board. Further, memory card interface 72 is sized and shaped to receive memory card 26 such that memory card 26 is communicatively coupled to the circuit board. In the exemplary embodiment, communications port 62 is also accessible through a corresponding aperture defined in housing 12 of MCB. Communications port 62 is communicatively coupled to the processing unit of the circuit board, and the processing unit is operable to transmit operating conditions data to analysis device 44 through communications port 62 (e.g., using communications cable 64). Thus, operating conditions data may then be transferred to analysis device 44 through communications cable 64, or may be transferred using memory card 26 (e.g., as described in method 50).

In the exemplary embodiment, communications port 62 is located in a different position on MCB 70 than communications port 62 on MCB 60 (shown in FIG. 5). Accordingly, as shown in FIG. 5 and FIG. 7, a communications port may be located at any easily accessible location on housing 12. In the embodiment of FIG. 5, communications port 62 is disposed on a forward, angled surface 63 of housing 12, proximate to a load lug 65. In the embodiment of FIG. 7, communications port 62 is disposed on a top surface 67 of housing 12, adjacent switch 24.

In the embodiment shown in FIG. 7, communications port 62 is positioned between memory card interface 72 and switch 24. Alternatively, memory card interface 72 may be positioned between communications port 62 and switch 24. Further, in yet another alternative embodiment, communications port 62 and memory card interface 72 may be positioned approximately the same distance from switch 24, such that communications port 62 and memory card interface 72 are located in a side-by-side arrangement.

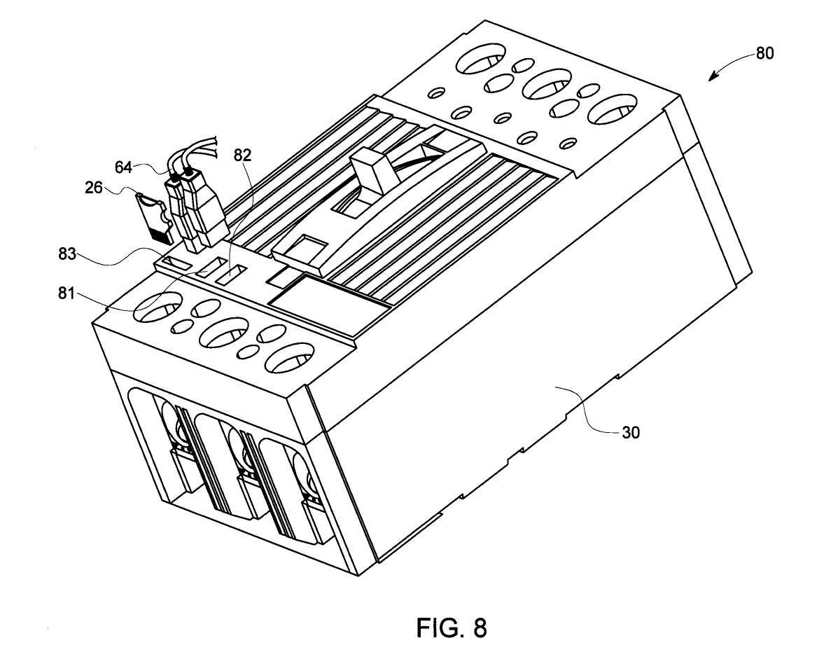

FIG. 8 illustrates an exemplary MCCB 80 including a plurality of communications interfaces. Specifically, in the exemplary embodiment MCCB 80 includes a first communications port 81, a second communications port 82, and a memory card interface 83 for receiving removable memory card 26. MCCB 80 functions substantially similar to MCCB 28 and the duplicative features will not be described in detail. Memory card interface 83 is in an accessible location and is communicatively coupled to a processing unit of a circuit board within MCCB 80. Memory card interface 83 is sized and shaped to receive memory card 26 and secure memory card 26 within housing 30 of MCCB 80.

First communications port 81 and second communication port 82 are also communicatively coupled to the processing unit. Further, the processing unit is operable to transmit operating conditions data to analysis device 44 (shown in FIG. 4) using first communications port 81 and/or second communications port 82 (e.g., via communications cables 64). First communications port 81 and second communications port 82 may provide redundant access to the circuit board of MCCB 80, or may access different portions of MCCB 80.

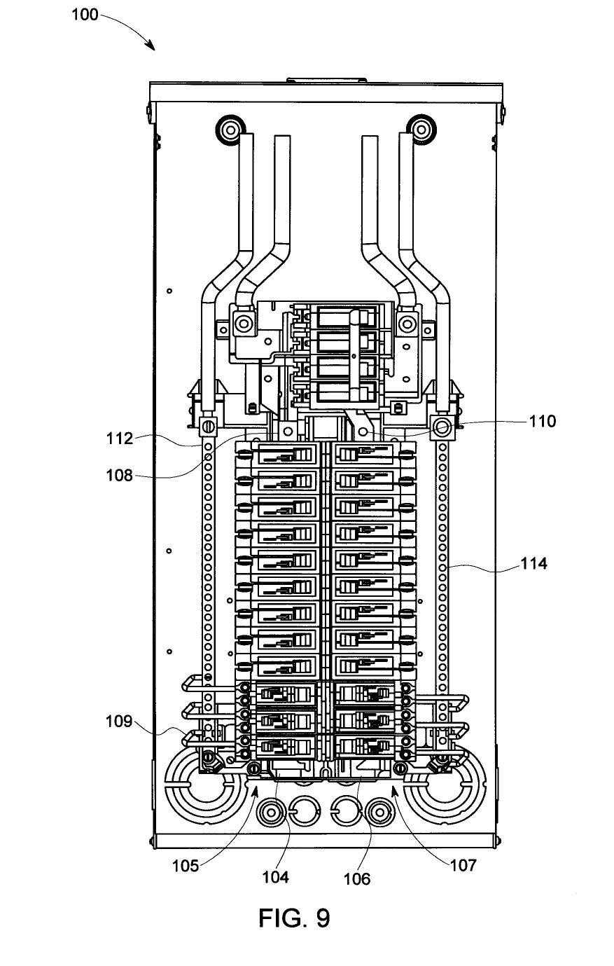

FIG. 9 is a front view of an exemplary electrical distribution center 100. In the exemplary embodiment, electrical distribution center 100 includes a first mounting rail 104 configured to receive a first plurality of circuit breakers 105, such as MCB 10, which may be organized along a first row. Electrical distribution center 100 further includes a second mounting rail 106 configured to receive a second plurality of circuit breakers 107, which may be organized along a second row. First mounting rail 104 includes a first bus bar 108 and second mounting rail 106 includes a second bus bar 110. First bus bar 108 and second bus bar 110 are configured to be electrically coupled to an electrical power source to distribute electrical power to circuit breakers 105 and 107 mounted on first mounting rail 104 and second mounting rail 106. Electrical distribution center 100 further includes a first neutral bus bar 112 and a second neutral bus bar 114. For at least some of circuit breakers 105 and 107, a neutral wire 109 is electrically coupled between the circuit breaker and first neutral bus bar 112 or second neutral bus bar 114. Circuit breakers 105 and 107 may include, for example, MCB 10, MCB 60, MCB 66, and/or MCB 70. Alternatively, circuit breakers 105 and 107 may include any suitable circuit breakers, including at least some circuit breakers without communications and processing capabilities.

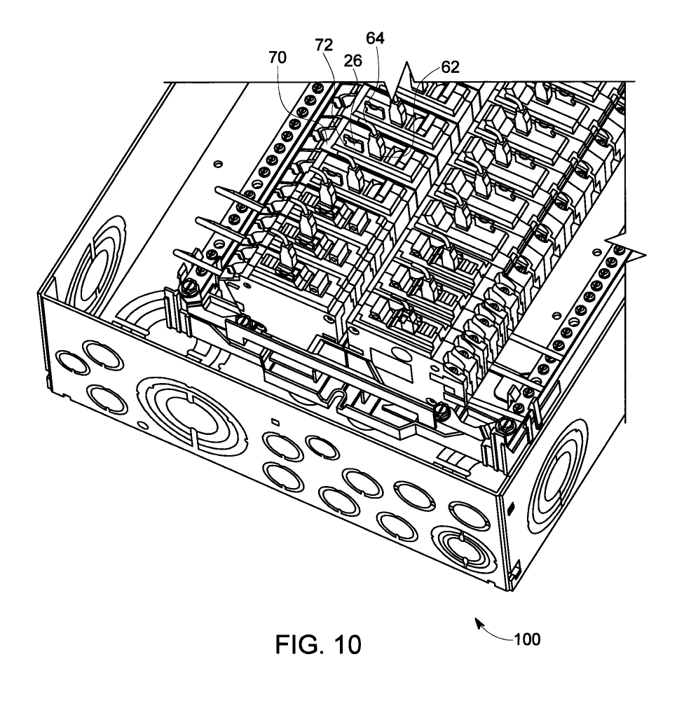

FIG. 10 is an enlarged perspective view of a portion of exemplary electrical distribution center 100. In the embodiment shown in FIG. 10, electrical distribution center 100 includes a plurality of MCBs 70 (shown in FIG. 7), each including communications port 62 and memory card interface 72. Further, for each MCB 70, an associated communications cable 64 and memory card 26 are coupled to communications port 62 and memory card interface 72, respectively. As can be seen in FIG. 10, communications port 62 and memory card interface 72 are readily accessible from a front of electrical distribution center 100. Accordingly, communications cable 64 and/or memory card 26 may be inserted into or removed from a desired MCB 70 without having to move or manipulate MCB 70 or electrical distribution center 100.

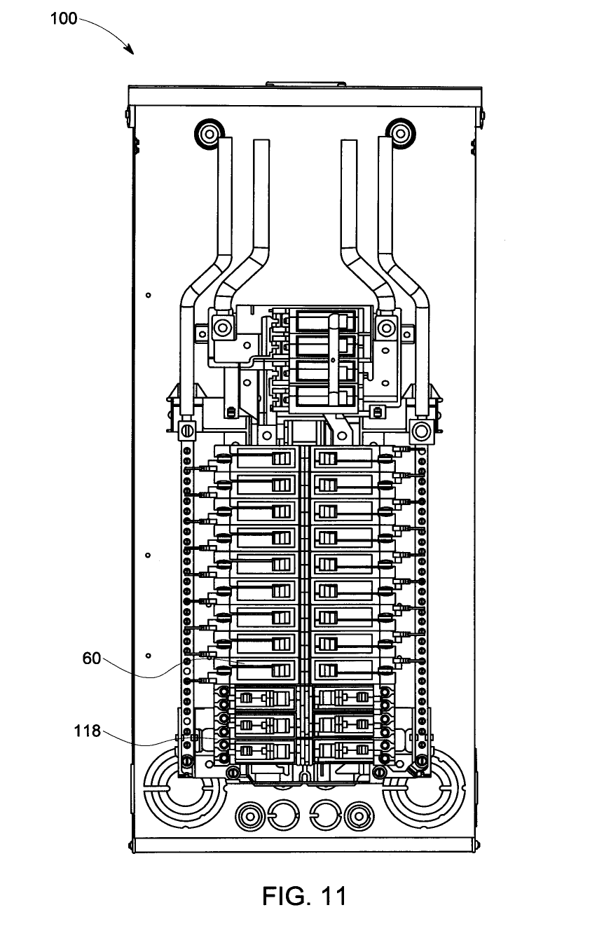

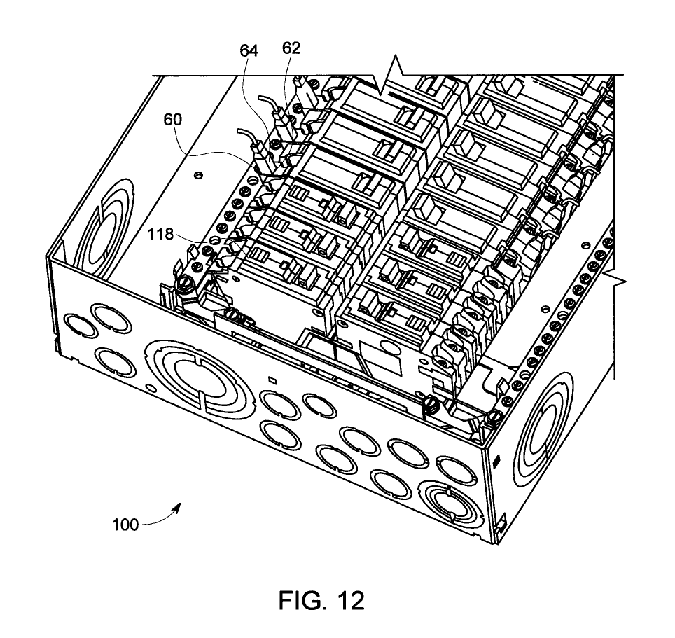

FIG. 11 is a front view of exemplary electrical distribution center 100 including an alternative arrangement of circuit breakers. FIG. 12 is an enlarged perspective view of a portion of electrical distribution center 100 as shown in FIG. 11. In the embodiment shown in FIGS. 11 and 12, electrical distribution center 100 includes a plurality of conventional circuit breakers 118 (i.e., circuit breakers without communications and processing capabilities) and a plurality of MCBs 60 (shown in FIG. 5). Each MCB 60 includes communications port 62, which, as shown in FIGS. 11 and 12, is readily accessible from the front of electrical distribution center 100. Accordingly, communications cables 64 may be inserted into or removed from a desired MCB 60 without having to move or manipulate MCB 60 or electrical distribution center 100.

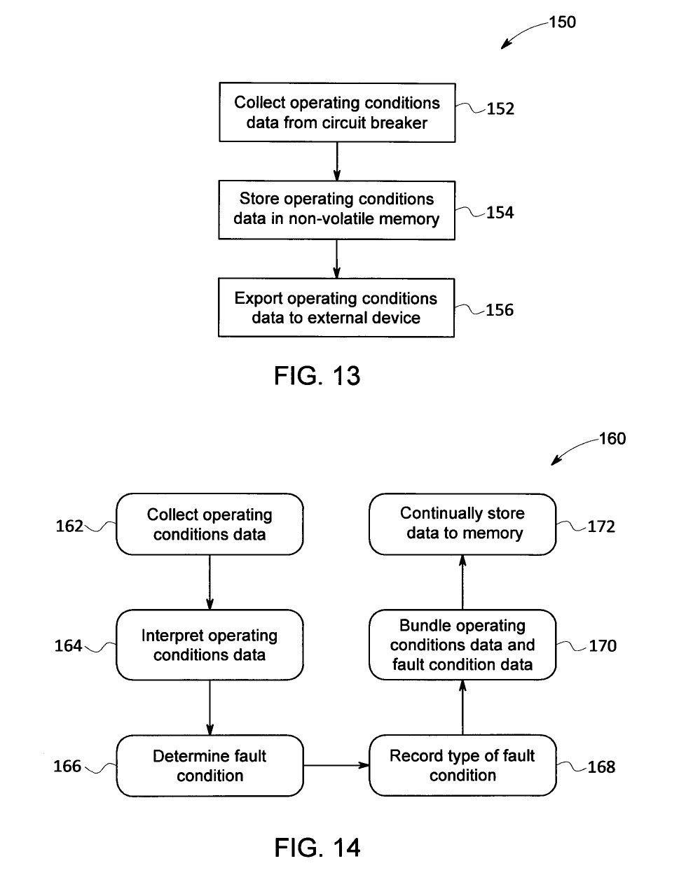

FIG. 13 is a flow chart illustrating an exemplary method 150 for acquiring operating conditions data from a circuit breaker. In block 152, operating conditions data is collected from a circuit breaker. For example, a processing unit of a circuit board installed on the circuit breaker may be communicatively coupled to sensing components that measure operating conditions for the circuit breaker. In block 154 the operating conditions data is stored to a non-volatile memory (e.g., included on the circuit board). In some embodiments, the processing unit may additionally or alternatively store the collected operating conditions data to a removable memory card. In block 156, the operating conditions data is exported to an external device. In some embodiments, the operating conditions data may be exported by physically removing a memory card from the circuit breaker, and connecting the memory card to the external device. In other embodiments, the operating conditions data may be exported by transmitting the operating conditions data over a wired or wireless communications channel.

FIG. 14 is a flow chart illustrating an exemplary method 160 for collecting and distributing operating conditions data for a circuit breaker. The method may be implemented by a processing unit of a circuit board installed on the circuit breaker. In block 162, the operating conditions data is collected. The operating conditions data may be data sensed by sensing components of the circuit breaker. In block 164, the operating conditions data is interpreted, or converted, into a predetermined format. For example, raw voltage values may be converted to a current value. In block 166, the interpreted operating conditions data is analyzed to determine whether any fault conditions have occurred. Fault conditions are conditions indicative of improper operation of the circuit breaker. For example, a fault condition may include an overcurrent condition. The determination at block 165 may be performed, for example, by comparing the interpreted operating conditions data to pre-programmed limits and/or by checking for particular operating conditions. The pre-programmed limits and/or particular operating conditions may be stored, for example, on a memory device of the circuit board.

If a fault condition is identified in block 166, then a type of the fault condition (e.g., whether the fault condition is an overcurrent condition) is recorded at block 168. The operating conditions data and any fault condition data (i.e., identifying the fault condition and the type of the fault condition) are then bundled at block 170. For example, the operating conditions data and fault condition data may be stored as a single data file. The bundled data is then stored to memory at block 172. The memory may be a non-volatile memory device on the circuit board, or a removable memory card coupled to the circuit breaker. Alternatively or additionally, the bundled data may be transmitted to a remote computing device over wired and/or wireless communications channels for storage at the remote computing device. The bundled data may further be transmitted to an alert system for alerting an operator, user, etc. to the presence of the fault condition.

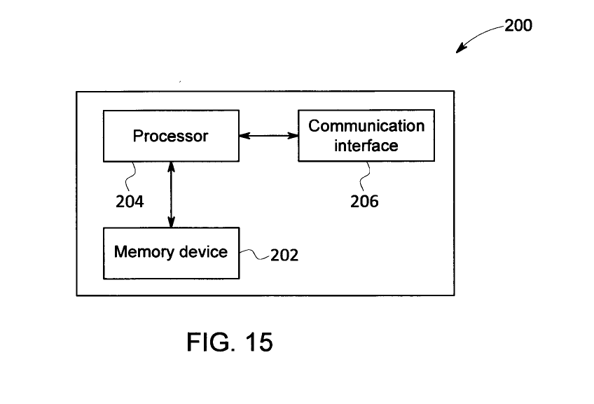

FIG. 15 is a block diagram of a circuit board 200 that may be installed on any of the circuit breakers described herein to provide those circuit breakers with communications and processing capabilities, as described herein. For example, circuit boards 20 and 38 (shown in FIGS. 1-3) may be implemented using circuit board 200.

In the exemplary embodiment, circuit board 200 includes a memory device 202 and a processor 204 coupled to memory device 202. Processor 204 may include one or more processing units or processing devices, such as, without limitation, a multi-core configuration. Processor 204 is any type of processor that permits circuit board 200 to operate as described herein. In some embodiments, executable instructions are stored in memory device 202. Circuit board 200 is configurable to perform one or more operations described herein by programming processor 204. For example, processor 204 may be programmed by encoding an operation as one or more executable instructions and providing the executable instructions in memory device 202. In the exemplary embodiment, memory device 202 is one or more devices that enable storage and retrieval of information such as executable instructions or other data. Memory device 202 may include one or more computer readable media, such as, without limitation, random access memory (RAM), dynamic RAM, static RAM, a solid-state disk, a hard disk, read-only memory (ROM), erasable programmable ROM, electrically erasable programmable ROM, or non-volatile RAM memory. The above memory types are exemplary only, and are thus not limiting as to the types of memory usable for storage of a computer program.

Memory device 202 may be configured to store any type of data, including, without limitation, operating conditions data associated with the circuit breaker. In some embodiments, processor 204 removes or “purges” data from memory device 202 based on the age of the data. For example, processor 204 may overwrite previously recorded and stored data associated with a subsequent time or event. In addition, or alternatively, processor 204 may remove data that exceeds a predetermined time interval.

In the exemplary embodiment, a communications interface 206 is coupled to processor 204. For example, communications interface 206 may include, without limitation, a memory card interface, a communications port, and/or a wireless communications interface, as described herein. Communications interface 206 may be, for example, a wired network adapter, a wireless network adapter, a mobile telecommunications adapter, a serial communication adapter, or a parallel communication adapter. Communications interface 206 may receive a data signal from or transmit a data signal to one or more remote devices, as described herein.

Embodiments of a circuit breaker, as described above, thus facilitate the analysis of fault conditions, operating conditions, and general troubleshooting of an electrical circuit. The circuit breakers described herein are capable of continuously storing operating condition data to a memory device that may be local or remote. In addition, in at least some embodiments, the memory device may be removable from the circuit breaker.

Exemplary technical effects of the circuit breakers described herein include, for example: (a) monitoring operating conditions prior to tripping the circuit breaker; (b) providing a real-time indication of circuit faults; (c) and facilitating remote monitoring of circuit breakers.

Exemplary embodiments of a circuit breaker and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with the systems and related methods as described herein. Rather, the exemplary embodiments can be implemented and utilized in connection with many applications.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A circuit breaker comprising:
a housing;
a circuit protection device disposed within said housing, said circuit protection device operable to i) sense operating conditions associated with at least one current path through said circuit breaker and ii) selectively open the at least current path based on the sensed operating conditions;
a processing device communicatively coupled to said circuit protection device, said processing device operable to collect operating conditions data from said circuit protection device, the operating conditions data including the sensed operating conditions and a trip indication that indicates whether said circuit protection device has opened the at least one current path; and
at least one communications interface communicatively coupled to said processing device, said at least one communications interface operable to receive the operating conditions data from said processing device to facilitate exporting the operating conditions data to a remote computing device.

2. The circuit breaker in accordance with claim 1, wherein said at least one communications interface comprises a memory card interface operable to engage a memory card, and wherein said processing device is operable to store the operating conditions data to the memory card when the memory card engages said memory card interface.

3. The circuit breaker in accordance with claim 2, wherein said memory card interface is accessible through an aperture defined in said housing.

4. The circuit breaker in accordance with claim 1, wherein said at least one communications interface comprises a communications port operable to engage a communications cable coupled to the remote computing device, and wherein said processing device is operable to transmit, using said communications port, the operating conditions data to the remote computing device through the communications cable.

5. The circuit breaker in accordance with claim 1, wherein said at least one communications interface comprises a wireless communications interface, and wherein said processing device is operable to wirelessly transmit, using said wireless communications interface, the operating conditions data to the remote computing device.

6. The circuit breaker in accordance with claim 1, wherein the operating conditions include at least one of a measured voltage, a measured current, a measured power, and a measured temperature.

7. The circuit breaker in accordance with claim 1, wherein said circuit protection device comprises at least one of arc fault circuit interrupt, a ground fault circuit interrupt, and a dual function circuit interrupt.

8. The circuit breaker in accordance with claim 1, wherein said at least one communications interface comprises a first communications interface and a second communications interface, wherein said first and second communications interfaces are proximate one another on a surface of said housing, wherein said first communications interface comprises a communications port operable to engage a communications cable, and wherein said second communications interface comprises a memory card interface operable to engage a memory card.

9. An electrical distribution center comprising:
a mounting rail comprising a bus bar;
at least one circuit breaker mounted to said mounting rail and electrically coupled to said bus bar, said at least one circuit breaker comprising:
a housing;
a circuit protection device disposed within said housing, said circuit protection device operable to i) sense operating conditions associated with at least one current path through said circuit breaker and ii) selectively open the at least one current path based on the sensed operating conditions;
a processing device communicatively coupled to said circuit protection device, said processing device operable to collect operating conditions data from said circuit protection device, the operating conditions data including the sensed operating conditions and a trip indication that indicates whether said circuit protection device has opened the at least one current path; and
at least one communications interface communicatively coupled to said processing device, said at least one communications interface operable to receive the operating conditions data from said processing device to facilitate exporting the operating conditions data to a remote computing device.

10. The electrical distribution center in accordance with claim 9, wherein said at least one communications interface comprises a memory card interface operable to engage a memory card, and wherein said processing device is operable to store the operating conditions data to the memory card when the memory card engages said memory card interface.

11. The electrical distribution center in accordance with claim 9, wherein said at least one communications interface comprises a communications port operable to engage a communications cable coupled to the remote computing device, and wherein said processing device is operable to transmit, using said communications port, the operating conditions data to the remote computing device through the communications cable.

12. The electrical distribution center in accordance with claim 11, wherein said communications port comprises a universal serial bus (USB) port.

13. The electrical distribution center in accordance with claim 9, wherein said at least one communications interface comprises a wireless communications interface, and wherein said processing device is operable to wirelessly transmit, using said wireless communications interface, the operating conditions data to the remote computing device.

14. The electrical distribution center in accordance with claim 9, wherein the operating conditions include at least one of a measured voltage, a measured current, a measured power, and a measured temperature.

15. The electrical distribution center in accordance with claim 9, wherein said circuit protection device comprises at least one of arc fault circuit interrupt, a ground fault circuit interrupt, and a dual function circuit interrupt.

16. The electrical distribution center in accordance with claim 9, wherein said at least one communications interface comprises a first communications interface and a second communications interface, wherein said first and second communications interfaces are proximate one another on a surface of said housing, wherein said first communications interface comprises a communications port operable to engage a communications cable, and wherein said second communications interface comprises a memory card interface operable to engage a memory card.

17. A method of monitoring operation of a circuit breaker, said method comprising:
sensing operating conditions associated with at least one current path through the circuit breaker, the operating conditions sensed by a circuit protection device disposed within a housing of the circuit breaker;
selectively opening, by the circuit protection device, the at least one current path based on the sensed operating conditions;
determining that the at least one current path was selectively opened, and generating a corresponding trip indication;
collecting, at a processing device disposed within the housing of the circuit breaker, operating conditions data from the circuit protection device, the operating conditions data including the sensed operating conditions and the trip indication; and
exporting, using a communications interface communicatively coupled to the processing device, the operating conditions data.

18. The method in accordance with claim 17, wherein the at least one communications interface includes a memory card interface, and wherein exporting the operating conditions data comprises storing the operating conditions data to a memory card engaging the memory card interface.

19. The method in accordance with claim 17, wherein the at least one communications interface includes a communications port, wherein a communications cable is coupled between the communications port and a remote computing device, and wherein exporting the operating conditions data comprises transmitting the operating conditions data to the remote computing device through the communications cable.

20. The method in accordance with claim 17, wherein the at least one communications interface includes a wireless communications interface, and wherein exporting the operating conditions data comprises transmitting the operating conditions data wirelessly transmitting the operating conditions data to a remote computing device using the wireless communications interface.
